(19) United States
(12) Patent Application Publication
(10) Pub. No.: US 2014/0041359 A1
(43) Pub. Date: Feb. 13, 2014

(54) RAPID STARTUP HEAT RECOVERY STEAM GENERATOR

(71) Applicant: Babcock & Wilcox Power Generation Group, Inc., Barberton, OH (US)

(72) Inventor: Melvin J. ALBRECHT, Homeworth, OH (US)

(21) Appl. No.: 13/914,695

(22) Filed: Jun. 11, 2013

Related U.S. Application Data
(60) Provisional application No. 61/682,470, filed on Aug. 13, 2012.

(51) Int. Cl. F02C 1/06; B21D 53/02

(52) U.S. Cl. CPC F02C 1/06; B21D 53/02
USPC 60/39.182; 29/890.031

(57) ABSTRACT

A rapid startup heat recovery steam generator (HRSG) comprises a gas inlet, a high pressure section, an optional intermediate pressure section, an optional low pressure section, and a gas outlet. At least one of the pressure sections includes a vertical steam separator.

### RELATED APPLICATION DATA

This patent application claims priority to U.S. Provisional Patent Application No. 61/682,470 filed Aug. 13, 2012 and titled “Rapid Startup Heat Recovery Steam Generator.” The complete text of this application is hereby incorporated by reference as though fully set forth herein in its entirety.

### BACKGROUND

The present disclosure relates in general, to the field of power generation. More particularly, the present disclosure is directed to a rapid startup heat recovery steam generator (HRSG) that includes one or more vertical steam separators. The HRSG can be used, for example, as a rapid startup boiler to quickly generate steam that can be used to drive a turbine and produce electricity very efficiently.

A HRSG is an apparatus used to extract or recover heat energy from a hot gas stream, such as a hot exhaust gas stream from a gas turbine. The extracted energy is used to convert water into steam, which may be used for power generation. HRSGs may also be referred to as waste heat recovery boilers or turbine exhaust gas boilers. HRSGs may be utilized in combined cycle power plants to enhance overall efficiency.

HRSGs may be unfired (i.e., use only the sensible heat of the gas as supplied), or may include supplemental fuel firing to raise the gas temperature to reduce heat transfer surface requirements, increase steam production, control superheated steam temperature, or meet process steam temperature requirements.

HRSGs include one or more pluralities of heat transfer surfaces, e.g. heat exchanger tubes, which may be referred to as boiler banks. When hot gas passes between and around the tubes of a boiler bank, depending on whether water or steam is flowing through the boiler bank, the water is converted to steam or the steam is superheated.

HRSGs can be grouped in a number of ways such as by the direction of exhaust gas flow (i.e., vertical or horizontal) or by the number of pressure levels (i.e., single pressure or multi-pressure). In a vertical type HRSG, exhaust gas flows vertically over horizontal tubes. In a horizontal type HRSG, exhaust gas flows horizontally over vertical tubes.

In a single pressure HRSG, steam is generated at a single pressure level through a steam drum, whereas multi-pressure HRSGs employ two (double pressure), three (triple pressure), or more steam drums. A triple pressure HRSG consists of three sections, i.e., a HP (high pressure) section, a IP (intermediate pressure) section, and a LP (low pressure) section. A reheat section may also be used to increase efficiency. Each section generally has a steam drum and an evaporator section where water is converted to steam. This steam is then passed through a superheater to raise the temperature past the saturation point.

As mentioned, HRSGs may include one or more steam drums. Steam drums are large, cylindrical vessels designed to permit separation of saturated steam from a steam-water mixture exiting the boiling heat transfer surfaces. In a natural circulation HRSG, the steam drums are oriented horizontally. Saturated steam is discharged through one or more outlet nozzles for direct use, heating, and/or power generation. Steam-free water is recirculated with the feedwater to the boiler bank(s) for further steam generation.

The steam drum typically uses centrifugal force generated through either tangential entry of the two-phase fluid into cyclones or through stationary propeller-type or torturous path devices. The centrifugal action literally “squeezes” the steam out of the steam-water mixture.

One of the limiting factors in the startup ramp rate of a typical HRSG is the steam drum soak time. Due to the thickness of the steam drum, HRSG suppliers specify a minimum hold time at low load startup to allow the steam drum to slowly increase in temperature and equalize between top and bottom metal temperatures. Failure to allow the steam drum to equalize in temperature results in lower metal temperatures along the bottom, water-wetted surface and higher metal temperatures along the upper, steam-wetted surface. This temperature differential leads to bowing in the drum, i.e., drum hump.

Drum hump places significant stress on the heavy riser and downcomer connections of the steam drum and may also result in exceeding the stress limits of the shell of the steam drum. In order to determine the amount of damage being done to the connections and/or shell material, HRSG suppliers typically recommend monitoring the number of fast start events in order to control the damage being done to components.

However, rapid startup boilers have and will continue to become more popular due to the attractiveness of renewable energy sources such as wind and solar. Wind and solar power generation is often inconsistent and thus there is a need for quick load shifting to replace power on electric grids to avoid brown and black outs.

It would be desirable to develop new HRSG designs for rapid startup boilers.

### BRIEF DESCRIPTION

The present disclosure relates, in various embodiments, to rapid startup heat recovery steam generators that include one or more vertical steam separators.

Disclosed in some embodiments is a rapid startup heat recovery steam generator (HRSG) comprising a gas inlet, a high pressure section, an optional reheat section, an optional intermediate pressure section, an optional low pressure section, and a gas outlet. The high pressure section comprises a high pressure steam-water separator and a plurality of high pressure evaporator tubes in fluid communication with the high pressure steam-water separator. The optional intermediate pressure section comprises an intermediate pressure steam-water separator and a plurality of intermediate pressure evaporator tubes in fluid communication with the intermediate pressure steam-water separator. The optional low pressure section comprises a low pressure steam-water separator a plurality of low pressure evaporator tubes in fluid communication with the low pressure steam-water separator. At least one of the high pressure steam-water separator, the intermediate pressure steam-water separator, and the low pressure steam-water separator is a vertical steam separator.

In some other embodiments, the intermediate pressure steam-water separator and/or the low pressure steam-water separator are vertical steam separators. In other embodiments, the intermediate pressure steam-water separator and/or the low pressure steam-water separator are steam drums.

The vertical steam separator may comprise a vertically extending cylindrical vessel having a top and a bottom portion; means for providing a steam/water mixture to the vessel for swirling the steam/water mixture in the separator for separating steam from water in the separator; vertically oriented scrubber means for removing water from steam located in the top portion of the vessel and arranged around an inside circumference of the separator; saturated steam connection means for conveying saturated steam from the vessel; feedwater supply means connected through a wall of the separator for conveying feedwater to the vessel; and means for conveying the feedwater and water separated from the steam from the vessel.

A flow path extending from the gas inlet to the gas outlet may be substantially horizontal or substantially vertical.

The vertical steam separator may be fluidly connected to the evaporator tubes via a plurality of tangential riser connections or straight riser connections.

Also disclosed is a method of retrofitting a HRSG. The method comprises removing a high pressure steam drum from a high pressure section of the HRSG; and replacing the high pressure steam drum with a high pressure vertical steam separator.

Optionally, the method further comprises removing an intermediate pressure steam drum from an intermediate pressure section of the HRSG; and replacing the intermediate pressure steam drum with an intermediate pressure vertical steam separator.

In some embodiments, the method further comprises removing a low pressure steam drum from a low pressure section of the HRSG; and replacing the low pressure steam drum with a low pressure vertical steam separator.

Further disclosed is a rapid startup heat recovery steam generator comprising a high pressure section, an intermediate pressure section, and a low pressure section. The high pressure section comprises a vertical steam separator, a high pressure evaporator fluidly connected to the vertical steam separator via a plurality of high pressure risers at a top end and via a high pressure downcomer/recycle line at a bottom end, and a high pressure superheater fluidly connected to the vertical steam separator via a high pressure dry steam conduit. The intermediate pressure section comprises an intermediate pressure steam drum, an intermediate pressure economizer fluidly connected to the intermediate pressure steam drum, an intermediate pressure evaporator fluidly connected to the intermediate pressure steam drum via intermediate pressure risers and an intermediate pressure downcomer/recycle line, and an intermediate pressure superheater fluidly connected to the intermediate pressure steam drum via an intermediate pressure dry steam conduit extending from the intermediate pressure steam drum. The low pressure section comprises a low pressure steam drum, a low pressure economizer fluidly connected to the low pressure steam drum, a low pressure evaporator fluidly connected to the low pressure steam drum via low pressure risers and a low pressure downcomer/recycle line, and a low pressure dry steam conduit extending from the low pressure steam drum.

These and other non-limiting aspects and/or objects of the disclosure are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIGS. 1A-1C illustrate a side, top, and perspective views of an embodiment of a heat recovery steam generator (HRSG) of the present disclosure.

FIGS. 2A and 2B illustrate side and top views of the high pressure section of the HRSG of FIGS. 1A-1C.

FIGS. 3A and 3B illustrate side and top views of the intermediate pressure section of the HRSG of FIGS. 1A-1C.

FIGS. 4A and 4B illustrate side and top views of the low pressure section of the HRSG of FIGS. 1A-1C.

FIG. 5 is a side, sectional view of a first embodiment of a vertical steam separator, which may be used in the HRSGs of the present disclosure.

FIG. 6 is a schematic plan view of an individual vertical steam separator illustrating how riser tubes connected thereto may be arranged.

FIG. 7 is a schematic, flattened view of the outside perimeter of the vertical steam separator of FIG. 6, illustrating how the riser tubes in one level are oriented and staggered with respect to riser tubes in an adjacent level.

FIG. 8 is a side, sectional view of a second embodiment of a vertical steam separator, which may be used in the HRSGs of the present disclosure.

FIG. 9 is a sectional plan view of the vertical steam separator of FIG. 8, viewed in the direction of arrows 8-8.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

A value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.”

As is known to those skilled in the art, heat transfer surfaces which convey steam-water mixtures are commonly referred to as evaporative boiler surfaces; heat transfer surfaces which convey steam therethrough are commonly referred to as superheating (or reheating, depending upon the associated steam turbine configuration) surfaces. Regardless of the type of heating surface, the sizes of the tubes, their material, diameter, wall thickness, number, and arrangement are based upon temperature and pressure for service, according to applicable boiler design codes, such as the American Society of Mechanical Engineers (ASME) Boiler and Pressure Vessel Code, Section I, or equivalent other codes as required by law.

The present disclosure relates to heat recovery steam generators, such as rapid startup HRSGs, that include one or more vertical steam separators. The vertical steam separator provides an economical and more reliable steam separation component for HRSG-type boilers. The use of the vertical steam separator during boiler startup helps to reduce emissions, increase efficiency, and maintain grid flexibility in order to offset unpredictable alternative power sources (e.g., wind and solar power). The vertical steam separator design allows for uninterrupted ramping of a gas turbine and may be particularly useful for increasing the boiler's availability during rapid startup or shutdown conditions and during extreme load changes.

Current rapid startup boilers use conventional steam drums. The high pressure steam drum is sized for a 2400 psia steam turbine and requires a drum thickness of from about 7 to about 8 inches. With this type of steam drum, fatigue problems can be seen in less than one-half of the design life of the boiler, e.g., failures typically occur in less than 15 years for a boiler with a design life of 30 years, if fast startups of less than 30 minutes from cold conditions are performed.

The vertical steam separator of the present disclosure performs a similar function as a conventional horizontal steam drum, but is configured so that a smaller, thinner diameter vessel system can be used. In some embodiments, the high pressure vertical steam separator has a wall thickness of from about 1.5 to about 4.5 inches, including from about 2.5 to about 3.5 and about 3 inches. This adjustment reduces thermal stresses, results in a longer thermal fatigue design life (because for the same temperature change, a thinner component will have a larger number of thermal fatigue cycles than a thicker component), and allows for quicker warm-ups and faster online operations. The thicknesses of the intermediate pressure vertical steam separator and the low pressure vertical steam separator may have thinner walls than the high pressure vertical steam separator.

The vertical steam separator may be supported at approximately the same elevation as the evaporator upper tube bundle headers. The thermal expansion of the vertical steam separator and the downcomer thus approximates the expansion of the tube bundle. The parallel expansion minimizes stresses at the supply and riser connection points.

Unlike a steam drum, the full cylindrical area of the vertical steam separator below the normal water level can be utilized for feedwater storage to the desired hold time, the diameter is reduced because the water holding volume is set by the length of the vertical steam separator instead of its diameter, and thus the thickness is reduced. For example, a 72 inch diameter high pressure steam drum could be 7 to 8 inches thick whereas two vertical steam separators having 36 inch diameters and 3 inch thicknesses could be used.

The cost of the vertical steam separators is expected to be less than the cost of a high pressure steam drum. Additional costs associated with the support steel and extended riser piping may offset some of the savings. However, the vertical steam separators may still be less expensive.

Accordingly, vertical steam separators provide many advantages over conventional horizontal steam drums including the elimination of drum humping and quick startup. The vertical steam separator can be positioned well, i.e., nested, into the overall design configuration of a HRSG. This produces additional advantages such as simplifying and reducing maintenance and/or replacement costs.

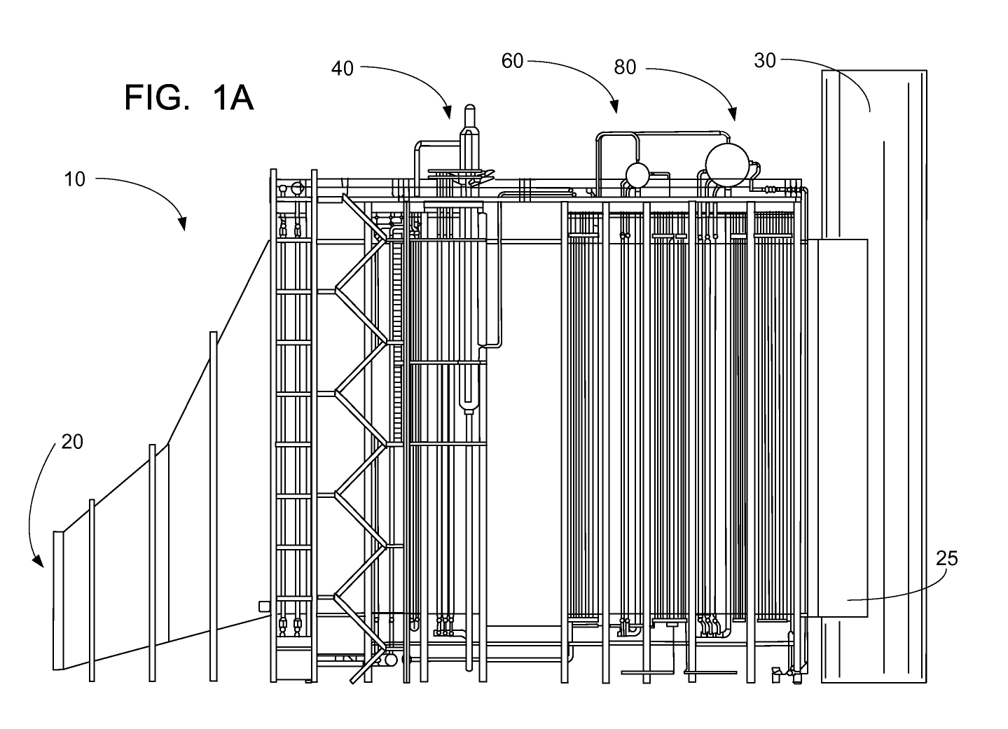

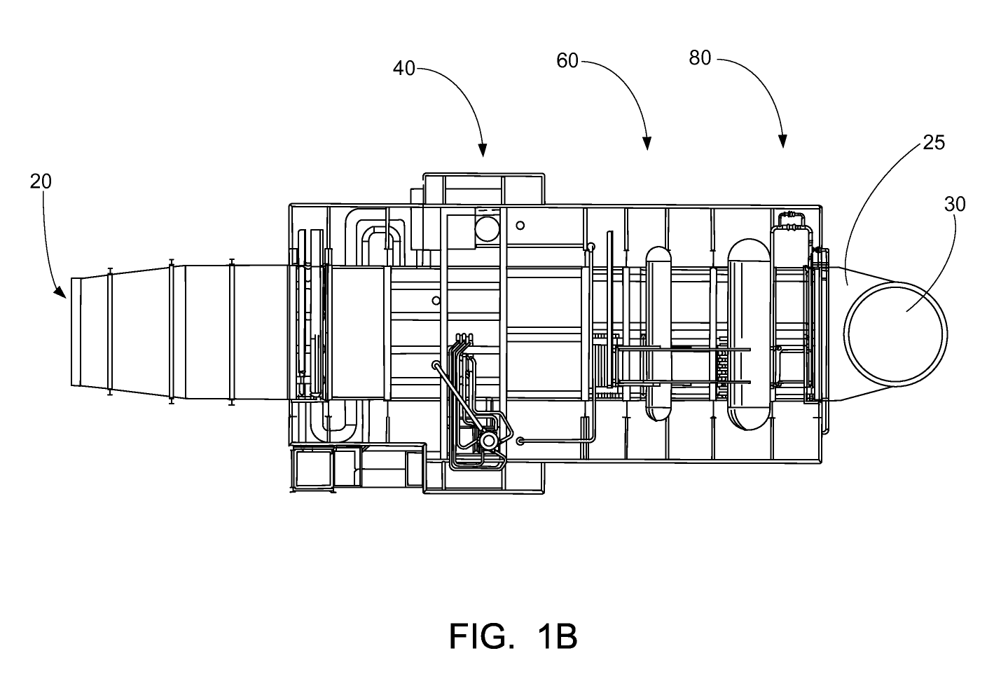

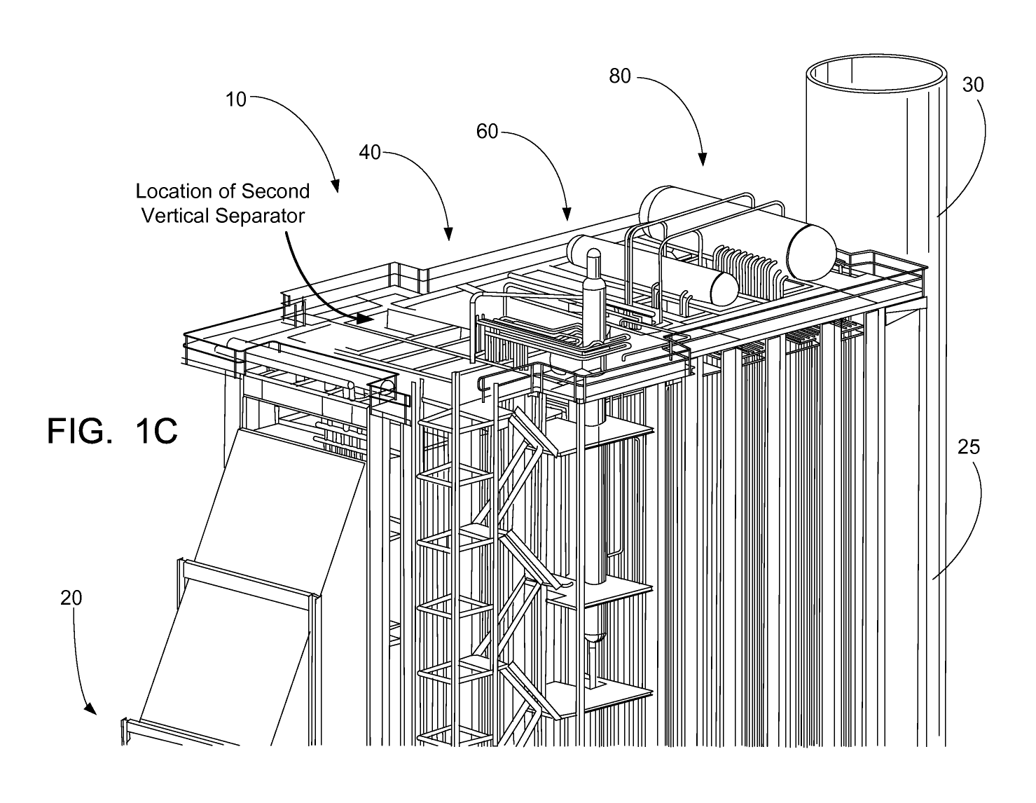

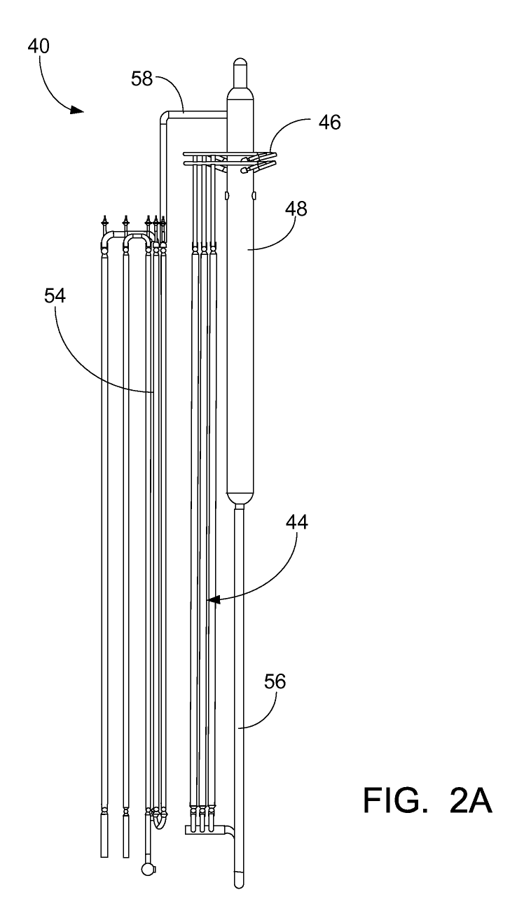

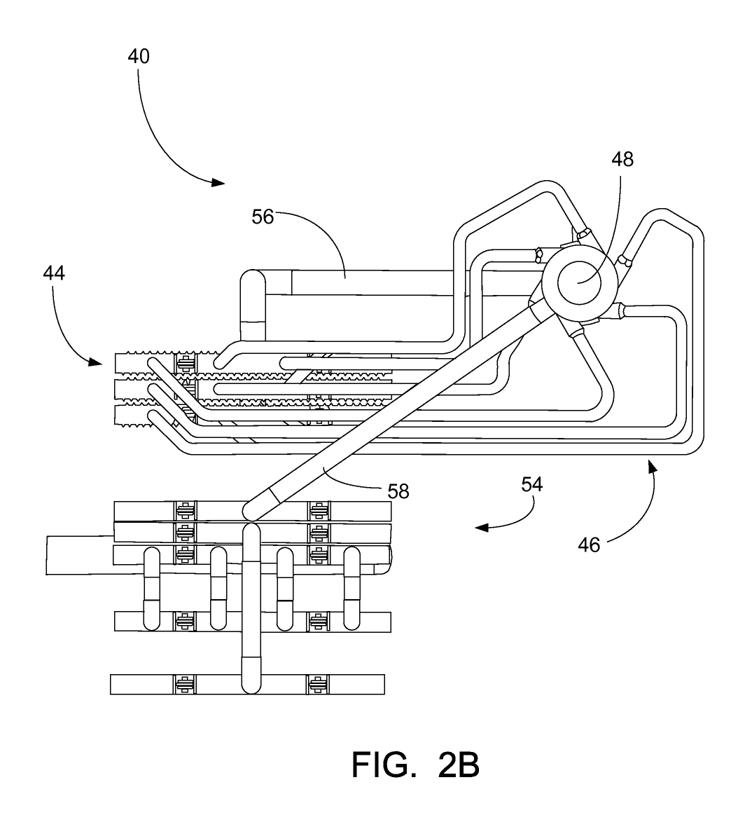

FIGS. 1A-1C illustrate an exemplary embodiment of a HRSG 10 of the present disclosure. The HRSG comprises three sections: a high pressure section 40; an intermediate pressure section 60; and a low pressure section 80. Hot gas enters the HRSG through the inlet 20 of the HRSG 10. The hot gas flows to the high pressure section 40 where some heat energy from the gas is transferred to produce high pressure steam. This leads to a reduction in the temperature of the gas. The gas flows to the intermediate pressure section 60 where heat is transferred from the gas to produce intermediate pressure steam. Then, the gas flows to the low pressure section 80 where heat is again transferred from the gas to produce low pressure steam. The cooled gas is discharged through outlet 25 to the stack 30. The high pressure section, intermediate pressure section, and low pressure section are more particularly depicted in FIGS. 2-4.

FIGS. 2A and 2B illustrate an exemplary high pressure section 40 in which gas flows from left to right in FIG. 2A and from bottom to top in FIG. 2B. The high pressure section may include an economizer for preheating water. Hot gas flowing between and around the evaporator 44 causes water therein to evaporate and form a wet steam, i.e., a water/steam mixture. The water/steam mixture rises and flows through risers 46 to the steam separator 48. The steam separator 48 is a vertical steam separator that separates the water and steam using a cyclone effect. Water is recycled back to the evaporator 44 via recycle line or downcomer 56. Dry steam, i.e., steam without water, flows through a dry steam conduit 58 to superheater 54. The temperature of the steam in the superheater 54 is further increased by the transfer of heat from the hot gas to generate superheated steam. The superheated steam generated in the high pressure section 40 may be utilized to generate electrical power, e.g., by rotating a steam turbine. As illustrated in FIG. 1B and FIG. 1C, the HRSG may be configured to fit one or more high pressure vertical steam separators 48. As illustrated in FIG. 1C, the vertical configuration allows easier access to the steam separator(s) 48 for easier maintenance, repair, or replacement via the stairs and maintenance platforms.

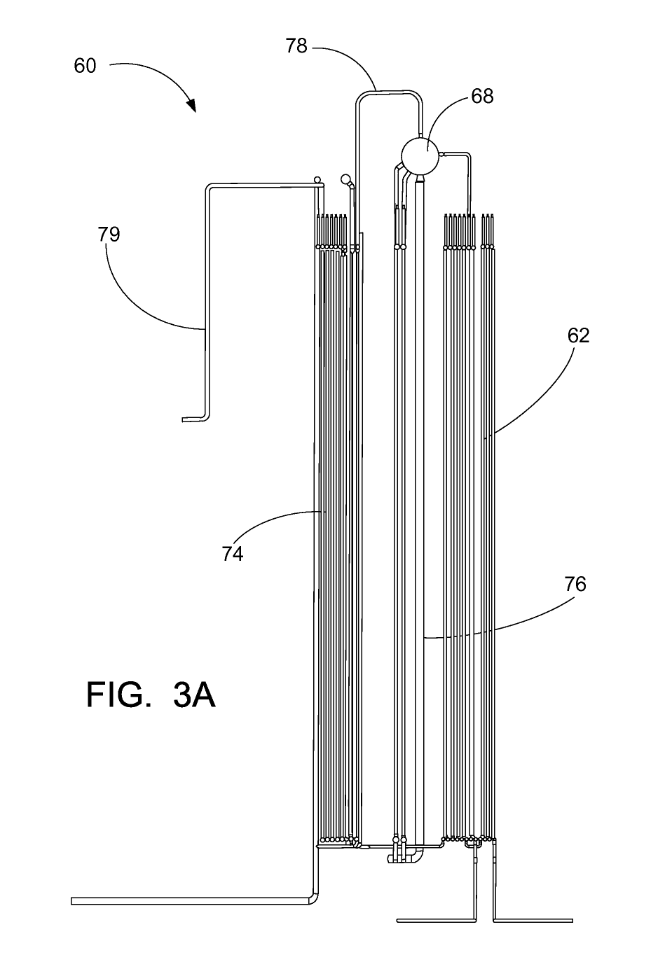

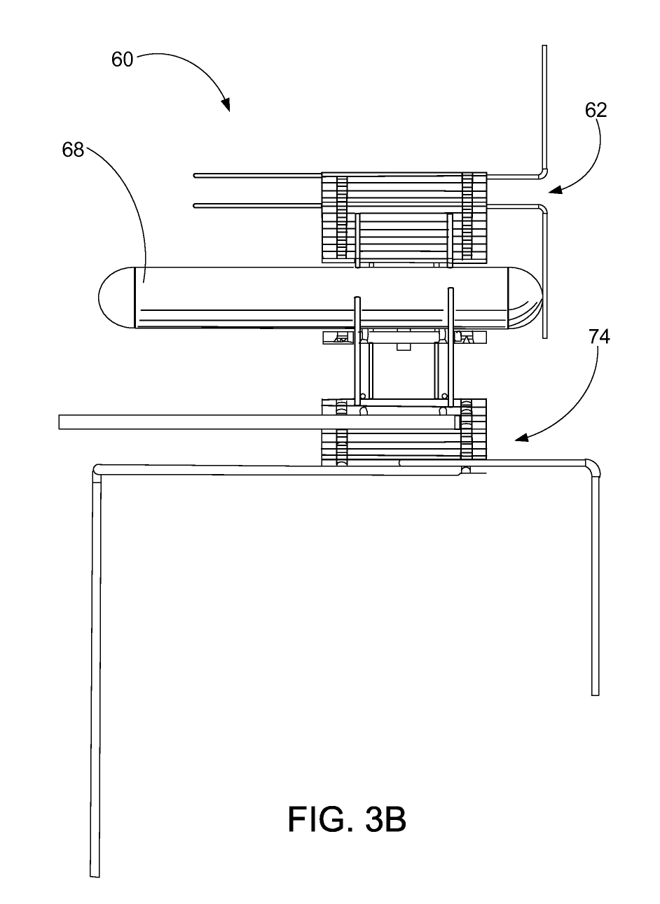

FIGS. 3A and 3B depict an exemplary intermediate pressure section 60. The intermediate pressure section 60 includes an economizer 62 for preheating water and an evaporator 64 for evaporating the water to generate wet steam. The wet steam rises and flows to steam separator 68. The steam separator 68 is a horizontally-oriented steam drum. In the steam drum 68, the wet steam is separated into steam and water. The water is recycled back to the evaporator 64 via downcomer 76. Dry steam flows to the superheater 74 via dry steam conduit 78. In the superheater 74, the dry steam is further heated to generate superheated steam. The superheated steam is discharged via line 79. The discharged steam may be utilized to generate electrical power or for other uses in a combined cycle power plant.

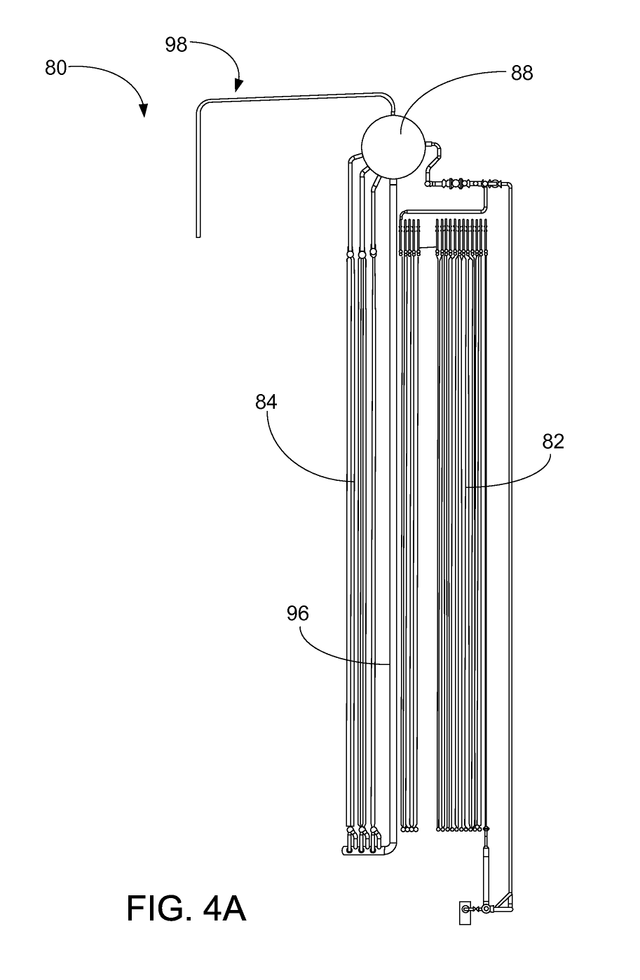

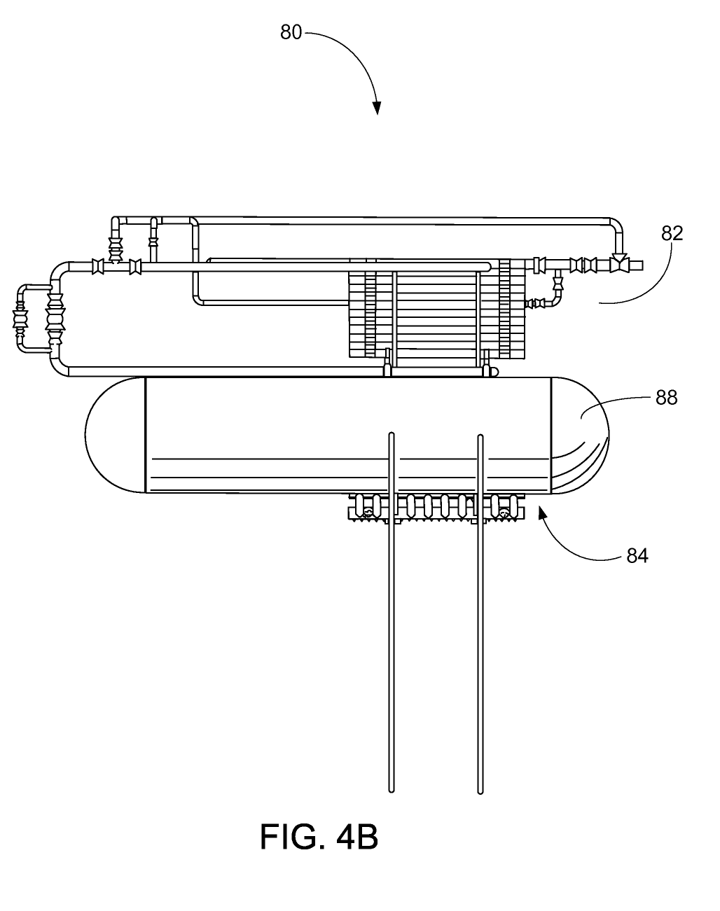

An exemplary low pressure section 80 is depicted in FIGS. 4A and 4B. The low pressure section 80 includes an economizer 82 for preheating water. The low pressure section 80 further includes an evaporator 84. Hot gas flowing between and around the tubes of the evaporator 84 transfers heat thereto, thereby generating wet steam in the evaporator 84. The wet steam rises and flows to the steam separator 88. The steam separator 88 is a steam drum. The steam drum 88 separates the wet steam into water, which is recycled back to the evaporator 84 via downcomer 96, and dry steam, which flows via dry steam conduit 98. The dry steam may be used as is for deaeration or for industrial process or may be sent to the low pressure superheater (not shown) for generating power from a low pressure steam turbine.

The vertical steam separator of the present disclosure may be designed as described in U.S. Pat. No. 6,336,429 to Wiener et al. and/or U.S. Patent Publication No. 2010/0101564 to Iannacchione et al. The disclosures of both of these documents are hereby incorporated by reference herein in their entireties.

To the extent that explanations of certain terminology or principles of the heat exchanger, boiler, and/or steam generator arts may be necessary to understand the present disclosure, the reader is referred to Steam/its generation and use, 41^{st} Edition, Kitto and Stultz, Eds., Copyright ©2005, The Babcock & Wilcox Company, the text of which are hereby incorporated by reference as though fully set forth herein.

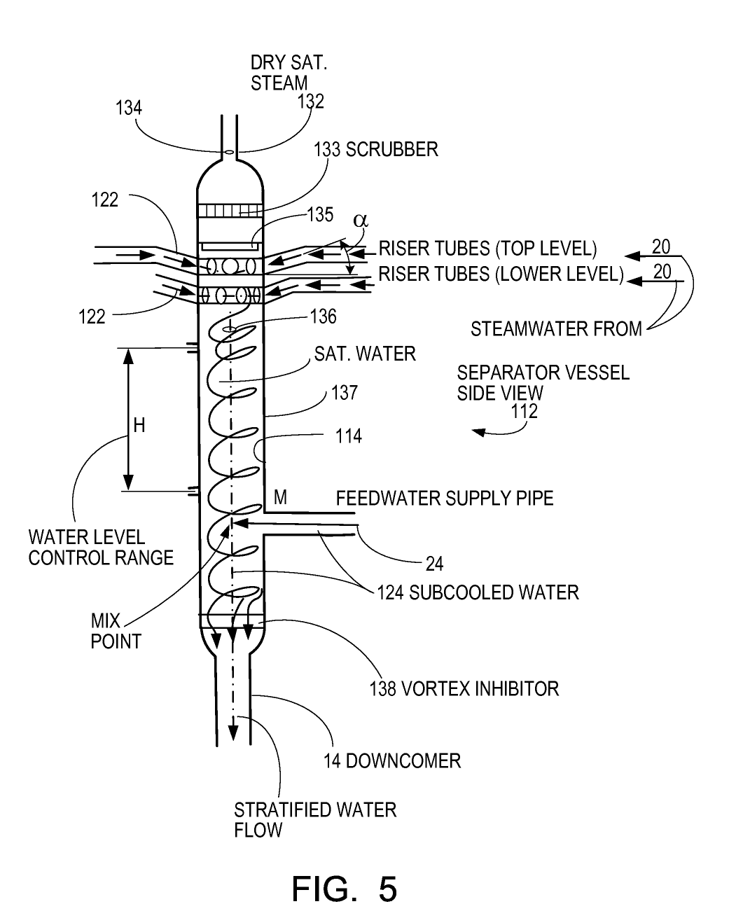

One exemplary vertical steam separator design is conceptually shown in FIG. 5. While in each separator 112, saturated steam 134 leaves through nozzles 132 (saturated steam connections) at the top of the separator 112, as illustrated in FIG. 5, while the separated, saturated water 136 flows downward to a lower portion of the steam/water separator 112 and is in rotation imparted through the centrifugal action at the top. The saturated steam 134 preferably passes through a scrubber element 133 at the upper portion of the separator 112 to ensure the steam is as dry as possible. A stripper ring 135 may also be employed in the upper portion of the separator 112 to prevent water swirling around the inside perimeter of the walls 137 of the separator 112 from being entrained in the exiting saturated steam 134. Feedwater 24 provided via conduits 124 enters the separator 112 at a lower point and mixes with the subcooled water at a mix point or region M before flowing downwardly across vortex inhibitors 138, such as baffles, into the actual downcomer 56. Due to the smaller water inventory in the separator 112, compared with that in a conventional single steam drum, the water level control range H in the separators 112 must be over a much greater height difference than in a conventional drum (e.g., ±6 feet compared with typically ±6 inches). Because of this aspect, according to the present disclosure fairly substantial water level (i.e., “pumping head”) variations can be accommodated even in high pressure (about 2500 psig) applications.

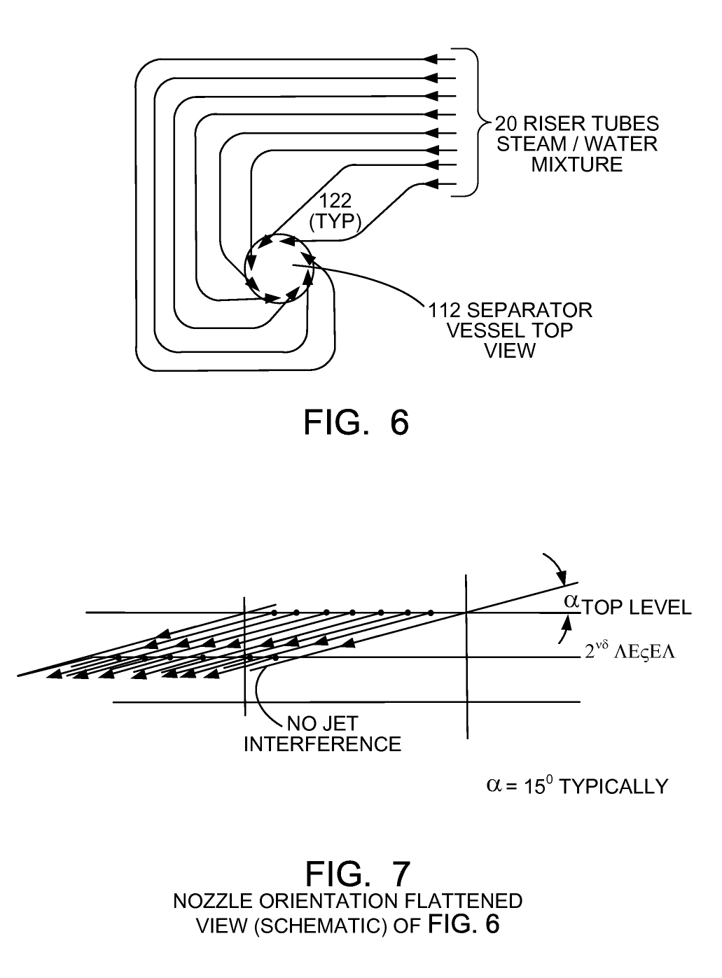

Returning now to FIG. 5, and next to FIGS. 6 and 7, the steam/water separator 112 is of a compact, efficient design. The steam/water mixture enters near the top of the separator vessel 112 through the riser tubes 46 through a plurality of nozzles 122, which are tangentially arranged around the periphery of the vessel 112, at one or possibly more levels (see FIGS. 5 and 6). The tangential entry is designed to create the formation of a rotating vortex of the steam/water mixture. The rotating vortex provides the centrifugal force needed to separate the steam from the water. FIG. 6 shows a top view of a vertical separator 112 and the tangential entry of riser nozzles 122 into the vessel 112. The nozzles 122 are inclined downward (typically 15 degrees) to use gravity which promotes the water flow downwards. This inclination also avoids interference between the jets coming from the plurality of nozzles 122. If more than one level of nozzles 122 is required, it becomes imperative to avoid interference between the jets from the various levels. This can be achieved through proper staggering of the nozzle 112 locations at different levels, as indicated in FIG. 7, which is a schematic, flattened view of the outside perimeter of the vertical steam/water separator 112 of FIG. 6 illustrating how the nozzles 122 for riser tubes 20 in one level are oriented and staggered with respect to the nozzles 122 for riser tubes 20 in an adjacent level. While two levels are illustrated, it is possible to have fewer or greater numbers of levels. The number depends upon a combination of factors, some being functional in nature, such as the amount of steam/water mixture being delivered to a given separator 112, others being structural in nature, such as the wall thickness and efficiency of the ligaments between adjacent nozzle penetrations on a given separator 112. This also forces the optimal separation of steam from the water through centrifugal action along the vessel inside wall 114 (inner surface).

The steam, which is at saturation condition, i.e., dry, but not superheated, is driven upward by the stripper ring 135 and through a torturous path (e.g., corrugated plate array) scrubber 133 which remove practically all residual moisture and droplets. Essentially dry, saturated steam 134 flows out from the separator 112 through one or more saturated steam connections 132 at the top of the separator 112. These saturated steam connections 132, in turn, convey the saturated steam 134 to the various steam-cooled circuits, before being superheated to the final steam temperature in the various superheater stages, from where it flows to the high pressure turbine.

The saturated water 136, on the other hand, flows along the inner surface 114 of the separator 112, forming a vortex that flows primarily in a downward direction and which mixes at M with the continuously supplied subcooled (below saturation) feedwater 24 from the economizer (not shown). With the formation of the vortex, a small portion of the water will move up the inner surface 114 to the stripper ring 135. The stripper ring 135 is used to contain the upward movement of the water 136 from reaching scrubber 133. The water mixture created through intense mixing of the feedwater 24 with the separated saturated water 136 is still subcooled and this water column still rotates due to the tangential motion of the saturated water imparted by the nozzles 122. A vortex inhibitor 138 at the bottom of the vessel 112 prevents this rotation to continue as the water flows into and down through the downcomer 56. A rotating fluid column could cause maldistribution of flow to the various furnace circuits connected to the downcomer 14 and limit the fluid transfer capability of the downcomer 56.

It is important to control the water level in the separator vessel to stay within a certain range H, typically several feet up and down from a set level. This will prevent water from being carried over into the steam flow at the top of the separator 112, which could damage the steam superheating surfaces downstream through water shock and carried over impurities, and steam from being carried under into the water flow headed into the downcomer 56, which would lighten the water column (reduced static pressure or pumping head) and increase the enthalpy (heat content) of the water, leading to premature boiling and an increased percentage of steam in the steam-water mixture in the furnace circuits. The latter would be detrimental to cooling of the furnace circuits, especially in connection with a reduced pumping head. Thus, larger separators 112 achieve the separating function that is conventionally assumed by a drum with many small centrifugal separators.

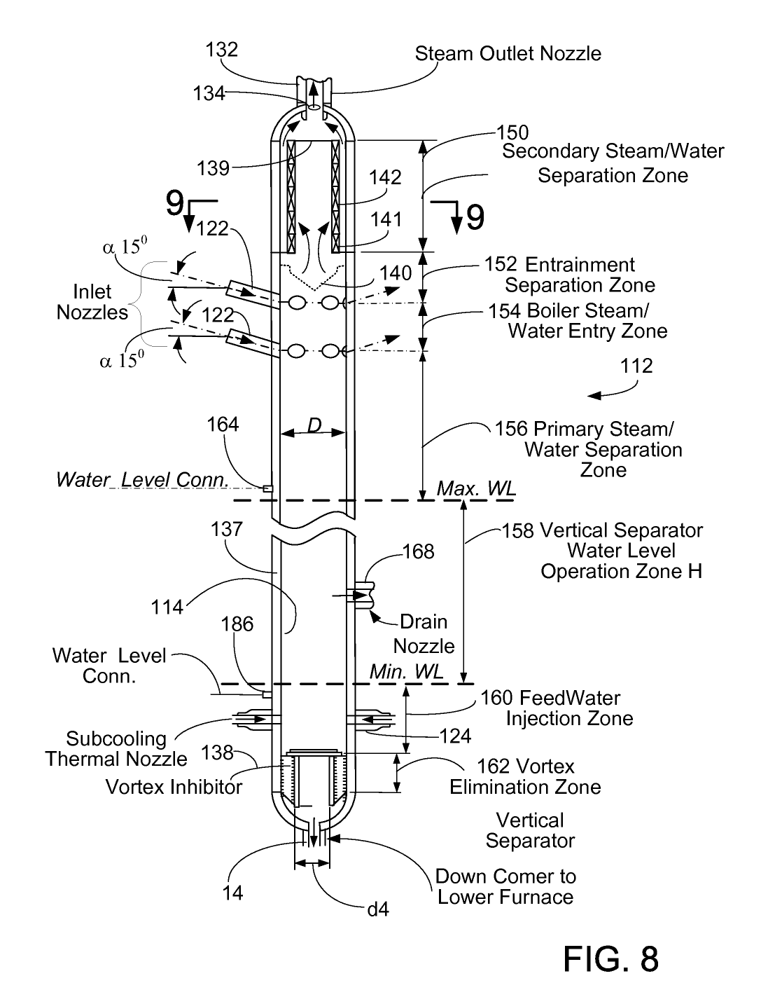

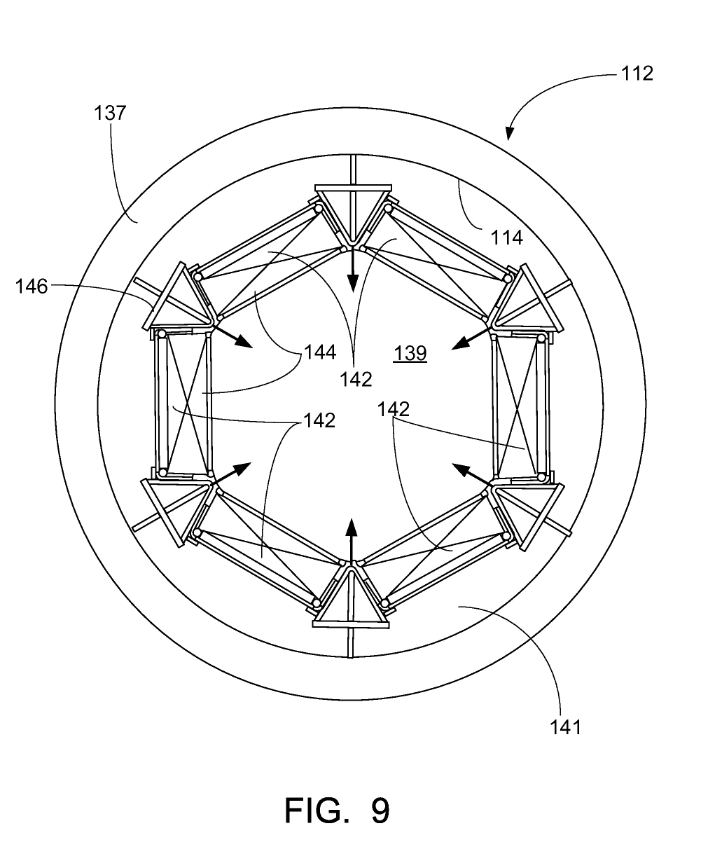

FIGS. 8 and 9 illustrate another embodiment of the vertical steam/water separator 112 according to the present disclosure. From a structural, as well as functional perspective, this embodiment employs many of the features of the embodiment illustrated in FIG. 5, and thus these common features will not be described again in detail. It is important to note, however, that the embodiment of FIGS. 8 and 9 employs a slightly different form of stripper ring, designated 140, and a completely different scrubber 142 arrangement. The stripper ring 140 in this embodiment again extends around the inner wall 114 (inside perimeter or circumference) of the wall 137 of the separator 112, just above the location where the one or more levels of tangential nozzles 122 connect to the separator 112. As shown, the stripper ring 140 may have a solid, annular portion adjacent the inside of the wall 137 and a conical, perforated portion in the center region of the separator 112. Steam can pass through the perforations in the scrubber ring 140, while water removed by the scrubbers 142 from the steam prior to its departure from the separator 112 can drain back down into a lower portion of the separator 112. The solid annular portion of the stripper ring 140 adjacent the inner wall 114 of the wall 137 is used to contain the upward movement of water 136 from reaching that portion of the separator 112 where secondary steam/water separation takes place.

Notably, in the embodiment of FIGS. 8 and 9, the scrubbers 142 comprise an array of vertically oriented individual scrubber elements 144 arranged around the inside perimeter of the separator 112, spaced from the inside surface 114 of the wall 137 of the separator 112 so as to create a substantially open, annular region 146 therebetween. It will be noted that the center portion 139 of the scrubber 142 is closed off so that the steam must pass through the scrubber 142. Likewise, the bottom end of the scrubber 142 is provided with a ring 141 extending between the scrubber 142 and the inside surface of the wall 137 of the separator 112. Both of these features ensure that the steam is conveyed through the scrubber 142. Thus, as the steam passes up into the top portion of the separator 112, it makes a gradual turn across and through these scrubber elements 144 comprising scrubber 142 and thence out of the separator 112 via nozzle 132. Supports 146 are provided to secure the individual scrubber elements 144 to the inside of the separator 112. The individual scrubber elements 144 may be sized so as to permit removal and inspection as required through conventional access openings. While FIG. 9 illustrates six (6) sets of scrubber elements 144, fewer or greater numbers could be employed, again as required by the amount of steam that must be scrubbed by a given separator 112. Further, it is preferred that the individual scrubber elements 144 are oriented so that, for example, the chevron-type plate elements are substantially vertical so that any collected moisture runs down along the plates, in contrast with a chevron-type plate arrangement where the plates are essentially horizontal. The latter would not be preferred because any water removed from the steam could have a greater tendency to lie on the plates and to be swept out and into the saturated connections 132, which is undesirable.

Returning to FIG. 8, from a functional viewpoint the separator 112 may be considered to have several zones along its height, each having or defining a particular function. At the top, the secondary steam/water separation zone 150 is where the final moisture is removed from the steam. The height of the individual vertical scrubber elements 144 comprising the scrubber 142 determines the extent of this zone 150. Below zone 150, an entrainment separation zone 152 encompasses the region from the bottom of the scrubber 142 to the top level of nozzles 122, and includes the stripper ring 140. The region where the tangential nozzles 122 are connected to and provide the steam/water mixture into the separator 112 may be defined as the boiler steam/water entry zone 154, and is the next lower zone.

The majority of the separation of the steam from the water takes place in the primary steam/water separation zone 156, as the water spirals downwardly to the bottom of the separator 112. Below that zone 156 is the region which will be substantially filled with water, albeit with a fluctuating water level, during steam generator operation, and this zone is designated the vertical separator water level operation zone, which defines the normal water level operation range. It has a height H of several feet, perhaps 6 to 30 feet, and upper 164 and lower 166 water level connections are provided for instrumentation to ensure proper separator 112 operation. A drain nozzle 168 may be provided in this region if desired.

Below the zone 158 is what is referred to as the feedwater injection zone 160, and comprises the area where feedwater 24 is introduced into the separator 112 for mixing with the separated water 136. Finally, a lower vortex elimination zone 162 is defined as the region below zone 160 downwards to the downcomer 14, and which contains any vortex inhibitor devices 138 as described above.

Methods for retrofitting an existing HRSG are also disclosed. The methods comprise removing a steam drum from a high pressure section. The methods further comprise replacing the steam drum with a vertical steam separator as described herein. Optionally, steam drums in the intermediate pressure section and/or the low pressure section may also be replaced with a vertical steam separator.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A rapid startup heat recovery steam generator (HRSG) comprising:
a gas inlet;
a high pressure section comprising a high pressure steam-water separator and a plurality of high pressure evaporator tubes in fluid communication with the high pressure steam-water separator;
an optional intermediate pressure section comprising an intermediate pressure steam-water separator a plurality of intermediate pressure evaporator tubes in fluid communication with the intermediate pressure steam-water separator;
an optional low pressure section comprising a low pressure steam-water separator a plurality of low pressure evaporator tubes in fluid communication with the low pressure steam-water separator; and
a gas outlet;
wherein at least one of the high pressure steam-water separator, the intermediate pressure steam-water separator, and the low pressure steam-water separator is a vertical steam separator.

2. The HRSG of claim 1, wherein the high pressure steam-water separator is a vertical steam separator.

3. The HRSG of claim 2, wherein the intermediate pressure steam-water separator and the low pressure steam-water separator are both vertical steam separators.

4. The HRSG of claim 2, wherein the intermediate pressure steam-water separator and the low pressure steam-water separator are both steam drums.

5. The HRSG of claim 1, wherein the intermediate pressure steam-water separator is the vertical steam separator.

6. The HRSG of claim 5, wherein the high pressure steam-water separator and the low pressure steam-water separator are both steam drums.

7. The HRSG of claim 1, wherein the low pressure steam-water separator is the vertical steam separator.

8. The HRSG of claim 7, wherein the high pressure steam-water separator and the intermediate pressure steam-water separator are both steam drums.

9. The HRSG of claim 1, wherein the intermediate pressure steam-water separator and the low pressure steam-water separator are both vertical steam separators.

10. The HRSG of claim 9, wherein the high pressure steam-water separator is a steam drum.

11. The HRSG of claim 5, wherein the high pressure steam-water separator is a steam drum.

12. The HRSG of claim 7, wherein the high pressure steam-water separator is a steam drum.

13. The HRSG of claim 1, wherein the vertical steam separator comprises:
a vertically extending cylindrical vessel having a top and a bottom portion;
means for providing a steam/water mixture to the vessel for swirling the steam/water mixture in the separator for separating steam from water in the separator;
vertically oriented scrubber means for removing water from steam located in the top portion of the vessel and arranged around an inside circumference of the separator;
saturated steam connection means for conveying saturated steam from the vessel;
feedwater supply means connected through a wall of the separator for conveying feedwater to the vessel; and
means for conveying the feedwater and water separated from the steam from the vessel.

14. The HRSG of claim 13, wherein the scrubber means comprises an array of vertically oriented individual scrubber elements arranged around the inside circumference of the separator, spaced from the inside surface of the wall of the separator so as to create a substantially open, annular region therebetween.

15. The HRSG of claim 1, wherein the vertical steam separator comprises:
a vertically extending cylindrical vessel having a top and a bottom portion;
at least one level of tangentially oriented nozzles connected to a wall of the vessel for providing a steam/water mixture to the vessel for swirling the steam/water mixture in the separator for separating steam from water in the separator;
vertically oriented scrubber means for removing water from steam, located in the top portion of the vessel and arranged around an inside circumference of the separator;
saturated steam connection means for conveying saturated steam from the vessel;
feedwater supply means connected for conveying feedwater to the vessel; and
means for conveying the feedwater and water separated from the steam from the vessel.

16. The HRSG of claim 15, wherein the tangentially oriented nozzles are inclined downwardly at an angle with respect to the horizontal direction.

17. The HRSG of claim 15, wherein the vertical steam separator comprises plural levels of inclined, tangentially oriented nozzles connected to the wall of the vessel, the nozzles of one level being staggered with respect to the nozzles of an adjacent level so as to avoid interference between jets of steam/water being conveyed by the nozzles from various levels.

18. The HRSG of claim 1, wherein the vertical steam separator comprises:
a vertically extending cylindrical vessel having a top and a bottom portion;
means for providing a steam/water mixture to the vessel for swirling the steam/water mixture in the separator for separating steam from water in the separator;
vertically oriented scrubber means for removing water from steam, located in the top portion of the vessel and arranged around an inside circumference of the separator;
a stripper ring positioned within the vessel below the scrubber means and above at least one level of tangentially oriented nozzles connected to a wall of the vessel for providing a steam/water mixture to the vessel for swirling the steam/water mixture in the separator for separating steam from water in the separator;
saturated steam connection means for conveying saturated steam from the vessel;
feedwater supply means connected for conveying feedwater to the vessel; and
means for conveying the feedwater and water separated from the steam from the vessel.

19. The HRSG of claim 18, wherein the stripper ring has a solid, annular portion adjacent an inside surface of the vessel and a conical, perforated portion in the center region of the separator.

20. The HRSG of claim 1, wherein the vertical steam separator comprises:
a vertically extending cylindrical vessel having a top and a bottom portion;
means for providing a steam/water mixture to the vessel for swirling the steam/water mixture in the separator for separating steam from water in the separator;
vertically oriented scrubber means for removing water from steam, located in the top portion of the vessel and arranged around an inside circumference of the separator;
saturated steam connection means for conveying saturated steam from the vessel;
feedwater supply means connected for conveying feedwater to the vessel;
vortex inhibitor means for reducing rotation of the feedwater and water as it is conveyed from the vessel; and
means for conveying the feedwater and water separated from the steam from the vessel.

21. The HRSG of claim 1, wherein the vertical steam separator is configured for receiving feedwater and a steam/water mixture, separating the steam from the water, conveying the separated steam from the separator, and mixing the feedwater with the separated water and conveying same from the separator, the vertical steam separator comprising:
a vertically extending cylindrical vessel having a top and a bottom portion and defining a plurality of zones therein, said zones including;
a secondary steam/water separation zone having scrubber means for removing a final portion of water from the steam;
an entrainment separation zone, located below the scrubber means and above a boiler steam/water entry zone, which provides the steam/water mixture into the separator via a plurality of inclined tangential nozzles;
a primary steam/water separation zone, located below the boiler steam/water entry zone, where water spirals downwardly to the bottom of the separator;
a vertical separator water level operation zone, located below the primary steam/water separation zone, which will be substantially filled with water having a fluctuating water level, during boiler operation;
a feedwater injection zone, located below the vertical separator water level zone, where the feedwater is introduced into the separator for mixing with the separated water; and
a lower vortex elimination zone, located below the feedwater injection zone, for reducing rotation of the feedwater and water as it is conveyed from the separator.

22. The HRSG of claim 1, wherein a flow path extending from the gas inlet to the gas outlet is substantially horizontal.

23. The HRSG of claim 1, wherein a flow path extending from the gas inlet to the gas outlet is substantially vertical.

24. The HRSG of claim 1, wherein the vertical steam separator is fluidly connected to the high pressure evaporator tubes via a plurality of tangential riser connections.

25. The HRSG of claim 1, wherein the vertical steam separator is fluidly connected to the high pressure evaporator tubes via a plurality of straight riser connections.

26. A method of retrofitting a HRSG, comprising:
removing a steam drum from the HRSG; and
replacing the steam drum with a vertical steam separator.

27. The method of claim 26:
wherein one or more steam drums selected from the group consisting of a high pressure steam drum, intermediate pressure steam drum, and low pressure steam drum is replaced with one or more vertical steam separators.

28. A rapid start heat recovery steam generator comprising a high pressure section, an intermediate pressure section, and a low pressure section;
wherein the high pressure section comprises a vertical steam separator, a high pressure evaporator fluidly connected to the vertical steam separator via a plurality of high pressure risers at a top end and via a high pressure recycle line at a bottom end, and a high pressure superheater fluidly connected to the vertical steam separator via a high pressure dry steam conduit;
wherein the intermediate pressure section comprises an intermediate pressure steam drum, an intermediate pressure economizer fluidly connected to the intermediate pressure steam drum, an intermediate pressure evaporator fluidly connected to the intermediate pressure steam drum via intermediate pressure risers and an intermediate pressure recycle line, and an intermediate pressure superheater fluidly connected to the intermediate pressure steam drum via an intermediate pressure dry steam conduit; and
wherein the low pressure section comprises a low pressure steam drum, a low pressure economizer fluidly connected to the low pressure steam drum, a low pressure evaporator fluidly connected to the low pressure steam drum via low pressure risers and a low pressure recycle line, and a low pressure dry steam conduit extending from the low pressure steam drum.
